(19) United States
(12) Patent Application Publication
(10) Pub. No.: US 2026/0138059 A1
(43) Pub. Date: May 21, 2026

(54) METAL FIBER FILTER, FILTER UNIT, AND VAPORIZER

(71) Applicant: NIPPON SEISEN CO., LTD., Osaka-shi, Osaka (JP)

(72) Inventors: Yuki KOZAI, Hirakata-shi, Osaka (JP); Norihiro KOKADO, Hirakata-shi, Osaka (JP)

(21) Appl. No.: 19/116,508

(22) PCT Filed: Dec. 19, 2024
(86) PCT No.: PCT/JP2024/045061

§ 371 Date: Mar. 28, 2025

(30) Foreign Application Priority Data
Mar. 22, 2024 (JP) 2024-047076

(51) Int. Cl. B01D 29/15; B01D 39/20

(52) U.S. Cl. CPC B01D 29/15; B01D 39/2044

(57) ABSTRACT

A metal fiber filter includes a support having a first end, a filter medium disposed radially outward of the support, and a first end member joined to a first end side of the support. The support includes a first support portion having a first outer diameter, and a second support portion having a second outer diameter larger than the first outer diameter. The filter medium is a sintered body of metal fibers and includes a medium body disposed radially outward of the first support portion, and a first extension portion disposed radially outward of the second support portion. The medium body and the first extension portion extend continuously in the axial direction with the third outer diameter. The first extension portion is joined to the first end member via the first joint portion including a first raised portion having a fourth outer diameter greater than the third outer diameter.

### TECHNICAL FIELD

The present invention relates to a metal fiber filter, a filter unit, and a vaporizer.

### BACKGROUND ART

Patent Document 1 describes a filter element including a sintered fiber medium. This filter element includes a cylindrical body having an outer diameter that decreases from the central portion of the element toward one end portion of the element, and the fiber medium has a density that increases from the central portion of the element toward the one end portion of the element. Such a filter element is expected to have the advantageous effect that welding at the end portion is facilitated due to the high density of the end portion.

### PRIOR PATENT DOCUMENTS

### Patent Document

Patent Document 1: Japanese Unexamined Patent Application Publication 2011-502743

### SUMMARY OF THE INVENTION

### Problem to be Solved by the Invention

As shown in FIG. 5, the filter element “a” described above may be housed in a housing b and used as a filter unit c. The housing b of the filter unit c includes an inlet d for fluid, an inlet flow path e that guides the fluid entering from the inlet d to the outer peripheral surface of the filter element “a” and an outlet f for extracting the fluid filtered by the filter element “a”.

In the filter unit c described above, the fluid flowing through the inlet flow path e tends to stagnate near the portion a1 of the filter element “a”, where the outer diameter is reduced at the axial end. Such fluid stagnation can lead to a decrease in filtration efficiency.

Furthermore, for example, as shown in FIG. 6, even when the filter element “a” is disposed on one wall surface h of a chamber g, fluid tends to stagnate in the region a2 between the wall surface h and the portion of the axial end of the filter element “a” where the outer diameter is reduced.

The present invention has been devised in view of the above-mentioned problems, and its primary objective is to provide a metal fiber filter and the like capable of suppressing fluid stagnation at the end portion of the filter medium (filter element).

### Means for Solving the Problem

The present invention relates to a metal fiber filter, which comprises a support having a cylindrical shape defining an axial direction and a radial direction, and having a first end, a filter medium disposed radially outward of the support, and a first end member joined to a first end side of the support, wherein the support includes a first support portion having a first outer diameter and, a second support portion having a second outer diameter larger than the first outer diameter, positioned on the first end side of the first support portion, the first support portion is formed with a plurality of through-holes, the second support portion is joined to the first support portion and forms the first end, the filter medium is a sintered body of metal fibers, the filter medium is disposed radially outward of the first support portion and includes a medium body for filtering fluid, and a first extension portion disposed radially outward of the second support portion and joined to the first end member, the medium body and the first extension portion extend continuously in the axial direction with a third outer diameter, the first extension portion is joined to the first end member via a first joint portion, and the first joint portion includes a first raised portion having a fourth outer diameter larger than the third outer diameter.

In the present invention, the first raised portion may be formed by a weld bead.

In the present invention, a wall thickness of the first extension portion may be in the range of 5% to 40% of a wall thickness of the medium body.

In the present invention, the wall thickness of the medium body may be 4.0 mm or more.

In the present invention, the first end member may have a fifth outer diameter greater than or equal to the third outer diameter.

In the present invention, it is preferable that the second support portion does not have a through-hole penetrating in the radial direction.

In the present invention, the fourth outer diameter may be at least 1.0 mm larger than the third outer diameter.

In the present invention, the porosity of the first extension portion may be smaller than the porosity of the medium body.

In the present invention, the porosity of the first extension portion may be 70% or less, and the porosity of the medium body may be 80% or more.

In the present invention, the first end member may be an end cap that closes the first end side of the support.

In the present invention, the support has a second end opposite to the first end, the support includes a third support portion on a second end side of the first support portion, the third support portion having a sixth outer diameter larger than the first outer diameter, and the third support portion is joined to the first support portion and forms the second end, a second end member is joined to the second end of the support, the filter medium includes a second extension portion disposed radially outward of the third support portion and joined to the second end member, the medium body and the second extension portion extend continuously in the axial direction at the third outer diameter, the second end side of the second extension portion is joined to the second end member via a second joint portion, and the second joint portion may include a second raised portion having a seventh outer diameter greater than the third outer diameter.

In the present invention, the second raised portion may be formed by a weld bead.

In the present invention, a wall thickness of the second extension portion may be in the range of 5% to 40% of a wall thickness of the medium body.

In the present invention, the first end member is an end cap that closes the first end side of the support, the second end member is a housing mounting member for securing the second end side of the support to the housing, and the second end member may have an opening for extracting fluid from the radially inner space of the support.

The present invention may be a filter unit that includes any of the metal fiber filters described above, and a housing capable of accommodating the metal fiber filter, wherein the housing includes an inlet for the fluid, an inlet flow path that guides the fluid entering from the inlet to the outer peripheral surface of the filter medium, and an outlet for extracting the fluid that has been filtered by the filter medium and passed through the through-holes of the first support portion and the opening of the second end member.

The present invention may also be a vaporizer using the metal fiber filter as described above.

### Effects of the Invention

The metal fiber filter of the present invention can reduce the risk of stagnation of the filtered fluid at the end portion of the filter medium and enhance filtration efficiency.

### BRIEF DESCRIPTION OF THE DRAWINGS

FIG. 1 is a cross-sectional view of a metal fiber filter of the present embodiment.

FIG. 2 is an enlarged view of portion II in FIG. 1.

FIG. 3 is an enlarged view of portion III in FIG. 1.

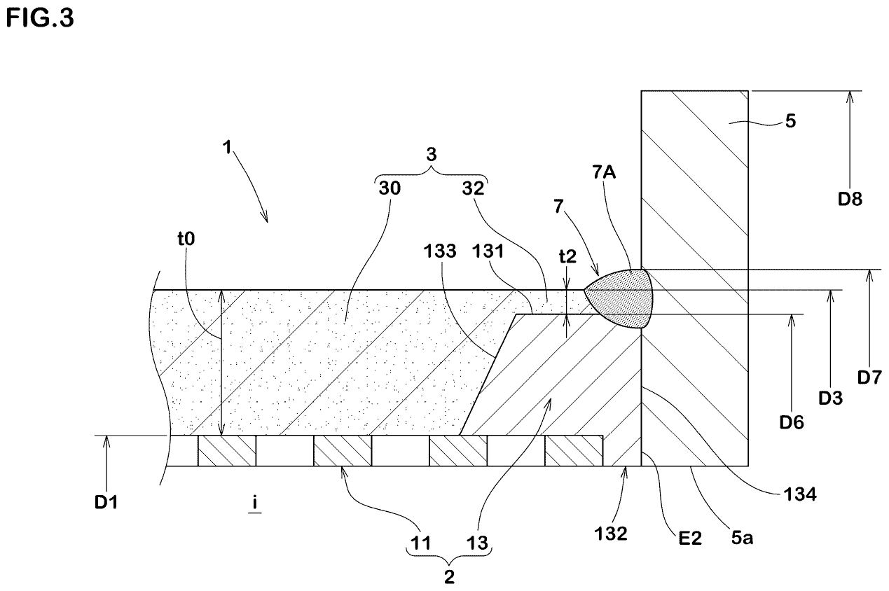

FIG. 4 is a cross-sectional view of a filter unit using the metal fiber filter of the present embodiment.

FIG. 5 is a cross-sectional view of another filter unit.

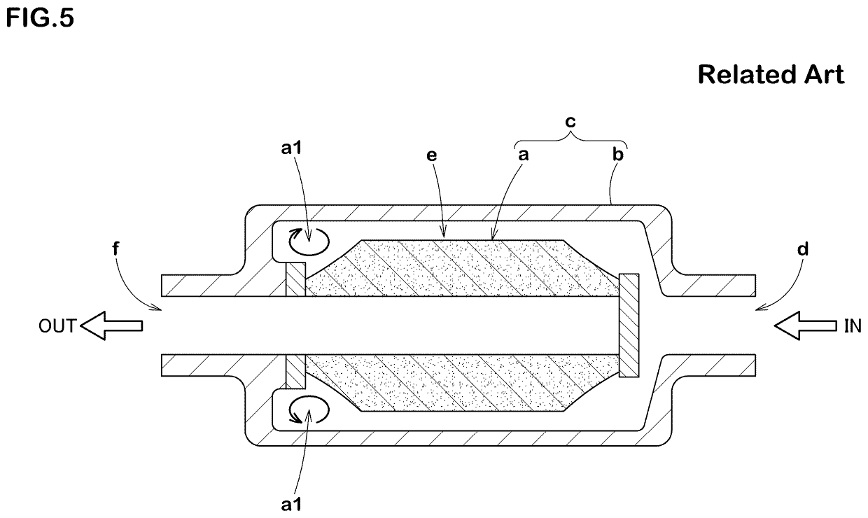

FIG. 6 is a cross-sectional view of yet another filter unit.

### EMBODIMENT FOR CARRYING OUT THE INVENTION

Hereinafter, an embodiment of the present invention will be described with reference to the drawings. It should be understood that the drawings include representations with dimensions and proportions different from those of the actual structure to aid in understanding the present invention. In cases where multiple embodiments exist, identical or common elements are assigned the same reference numerals throughout the specification, and redundant descriptions are omitted. Furthermore, the specific configurations represented in the embodiments and figures are provided for understanding the content of the present invention, and the present invention is not limited to the specific configurations shown in the drawings.

### [Metal Fiber Filter]

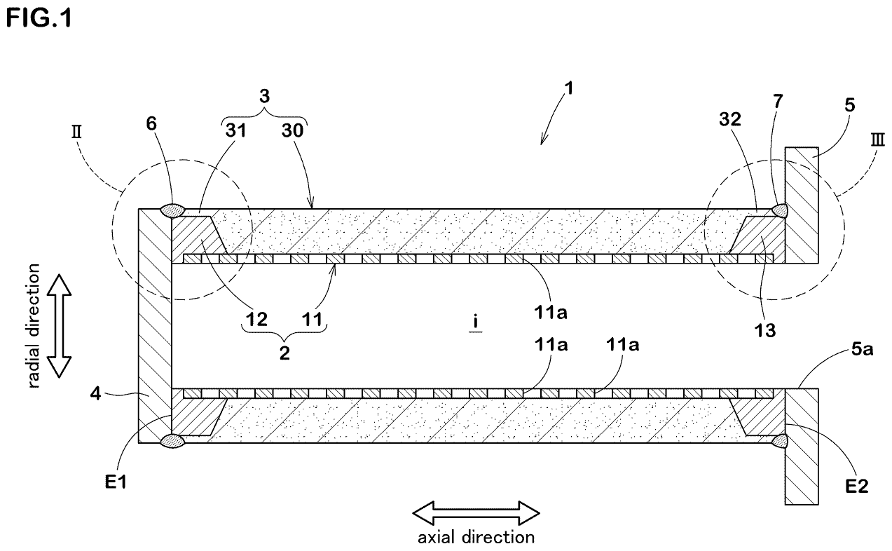

FIG. 1 is a cross-sectional view of a metal fiber filter 1 of the present embodiment. As shown in FIG. 1, the metal fiber filter 1 of the present embodiment includes a support 2, a filter medium 3 disposed radially outward of the support 2, and a first end member 4 arranged on one end side of the support 2 in the axial direction. Additionally, the metal fiber filter 1 of the present embodiment is shown to include a second end member 5 arranged on the other end side of the support 2 in the axial direction.

The metal fiber filter 1 of the present embodiment is used for capturing foreign substances such as fine particles in fluid. In particular, the metal fiber filter 1 of the present embodiment is utilized as a high-performance filter that captures foreign substances with high filtration efficiency from fluids used in manufacturing processes of industrial products, such as semiconductors, which are produced in extremely clean environments. However, the fluid to be filtered by the metal fiber filter 1 of the present invention is not limited to any specific type.

### [Support]

The support 2 is configured in a cylindrical shape that defines the axial direction and the radial direction perpendicular thereto. In a cross-section of the support 2 taken in a plane perpendicular to the axial direction, the direction along its outer surface is defined as the circumferential direction. The support 2 extends in the axial direction from a first end E1 to a second end E2. The radially inner portion of the support 2 constitutes a space “i”. In the present embodiment, the support 2 has a cylindrical shape with a circular cross-section. In other variations, the support 2 may have a cylindrical shape with a polygonal cross-section.

The support 2 is formed of a metal material. The metal material is not particularly limited; however, for example, stainless steel may be employed, with austenitic stainless steel being particularly suitable due to its excellent workability and corrosion resistance. In a preferred embodiment, the support 2 of the present embodiment is formed of SUS 316L, which offers superior corrosion resistance.

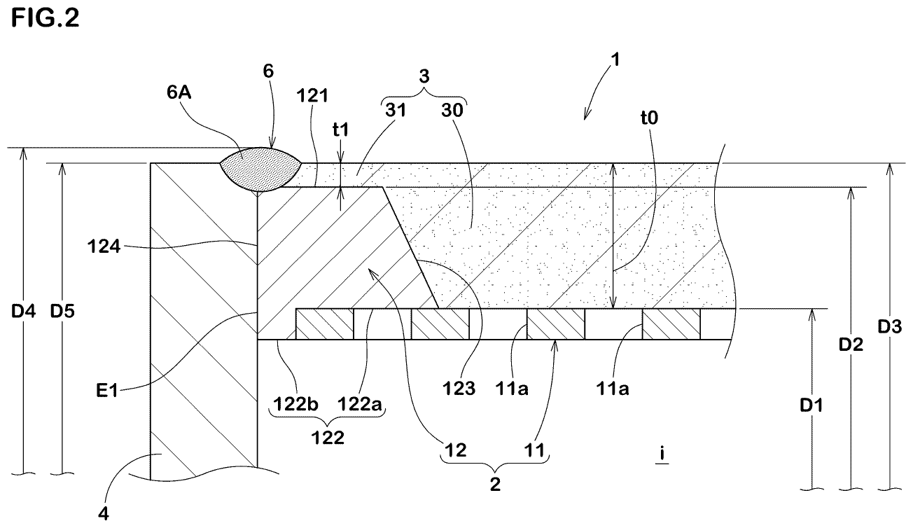

FIG. 2 shows an enlarged view of portion II in FIG. 1. As shown in FIG. 1 and FIG. 2, the support 2 includes a first support portion 11 and a second support portion 12 provided on the first end E1 side of the first support portion 11. In the present embodiment, the first support portion 11 has a sufficiently greater length in the axial direction compared to the second support portion 12.

### [First Support Portion]

The first support portion 11 is formed in a cylindrical shape having a first outer diameter D1. In the present embodiment, the first support portion 11 extends continuously in the axial direction with the first outer diameter D1.

The first support portion 11 is formed with a plurality of through-holes 11a. Accordingly, fluid on the radially outer side of the first support portion 11 can flow into the internal space “i” of the first support portion 11 through the through-holes 11a. In the present embodiment, the first support portion 11 may be formed, for example, by processing a metal plate with regularly pitched holes, such as perforated metal, into a cylindrical shape. The hole diameter and shape of the through-holes 11a are not particularly limited and can be set appropriately according to the application. In the present embodiment, the through-holes 11a are circular with a diameter of 1.5 mm and are arranged at approximately equal intervals in both the axial and circumferential directions.

### [Second Support Portion]

The second support portion 12 has a second outer diameter D2 that is larger than the first outer diameter D1. In other words, the second support portion 12 protrudes radially outward from the outer surface of the first support portion 11. In the present embodiment, the second support portion 12 is formed in an annular shape and includes, for example, a radially outer peripheral surface 121, a radially inner peripheral surface 122, an axially inner end surface 123, and an axially outer end surface 124. It should be noted that, in this specification, with respect to the axial direction, “inner” and “outer” indicate relative directions, where “outer” refers to the direction toward the axial end, and “inner” refers to the direction toward the axial center.

The outer peripheral surface 121 of the second support portion 12 extends continuously in the axial direction with the second outer diameter D2, for example.

In the embodiment, an end portion of the first support portion 11 is fixed to the inner peripheral surface 122 of the second support portion 12, for example. More specifically, the inner peripheral surface 122 is formed as a stepped surface including a recess 122a that extends in the axial direction with a constant inner diameter, and a protrusion 122b that is positioned on the first end E1 side of the recess 122a and protrudes radially inward from the recess 122a. Then, the end portion of the first support portion 11 is disposed in the recess 122a, and the axially outer end surface of the first support portion 11 is in contact with the stepped surface of the protrusion 122b. Additionally, the first support portion 11 and the second support portion 12 are fixed together by welding or the like. In the present embodiment, the inner peripheral surface of the first support portion 11 and the inner peripheral surface of the protrusion 122b of the second support portion 12 are formed to be continuous in the axial direction.

In the present embodiment, the axially inner end surface 123 of the second support portion 12 has, for example, a tapered surface whose outer diameter gradually decreases toward the axial inner side.

In the present embodiment, the axially outer end surface 124 of the second support portion 12 is, for example, formed as a plane perpendicular to the axial direction, and this plane forms the first end E1 of the support 2.

In the present embodiment, the second support portion 12 is made of a solid, integral material without any through-holes extending in the radial direction. Accordingly, fluid cannot pass through the second support portion 12.

### [Filter Medium]

The filter medium 3 is fixed to the radially outer peripheral surface of the support 2. Accordingly, in the present embodiment, the filter medium 3 has a cylindrical shape corresponding to the cylindrical shape of the support 2. In the present embodiment, the filter medium 3 is fixed to the radially outer peripheral surface of the support 2 during sintering. However, the method of fixing the filter medium 3 to the support 2 is not particularly limited.

The filter medium 3 is composed of a sintered body of metal fibers. The metal fibers constituting the filter medium 3 are not particularly limited; however, for examples include stainless steel, particularly austenitic stainless steel with excellent corrosion resistance (e.g., SUS 316L), nickel alloys, pure nickel, and the like, which may be appropriately used. The diameter of the metal fibers used in the filter medium 3 is also not particularly limited. However, to enhance filtration efficiency, short fibers with a diameter of approximately 0.5 to 10 μm (micrometer) are preferable. Such metal fibers, after being arranged on the outer peripheral surface of the support 2, are placed into a mold or the like and subjected to heat and pressure from the outside. As a result, the assembly of metal fibers is integrally formed on the outer peripheral surface of the support 2 as a cylindrical sintered body. The filter medium 3 thus formed has a porous structure with fine voids through which fluid can pass, thereby functioning as a filtration member with high filtration accuracy.

The filter medium 3 includes a medium body 30 and a first extension portion 31 formed on the first end E1 side of the medium body 30. Additionally, in the present embodiment, the filter medium 3 includes a second extension portion 32 formed on the second end E2 side of the medium body 30.

The medium body 30 is the portion of the filter medium 3 that is disposed radially outward of the first support portion 11. The medium body 30 serves as the part of the filter medium 3 that performs the primary filtration function. In the present embodiment, the medium body 30 has a cylindrical shape extending in the axial direction, corresponding to the shape of the support 2. The first extension portion 31 is the portion of the filter medium 3 that is disposed radially outward of the second support portion 12. The first extension portion 31 is integrated with the medium body 30. The first extension portion 31 is used for joining with the first end member 4, as described later.

In FIG. 2, in the present embodiment, the medium body 30 and the first extension portion 31 extend continuously in the axial direction with a third outer diameter D3. That is, the medium body 30 and the first extension portion 31 are axially continuous with the same outer diameter, without a substantial step. However, since the filter medium 3 is a sintered body of metal fibers, microscopic observation reveals the presence of fine irregularities on the surface of the filter medium 3. Accordingly, the term “without a substantial step,” as described above, is intended to allow for the presence of fine surface irregularities that are unavoidably inherent in a sintered body of metal fibers. More specifically, the term “without a substantial step” should be understood to mean that a person skilled in the art, under normal attention, can recognize through visual (macroscopic) observation that the medium body 30 and the first extension portion 31 are continuous in the axial direction with the same outer diameter. It should be noted that, in microscopic observation, the difference between the maximum diameter and the minimum diameter of the filter medium 3 is preferably 2 mm or less, more preferably 1.5 mm or less, to more effectively suppress fluid stagnation.

### [First End Member]

The first end member 4 is joined to the first end E1 side of the support 2. In the present embodiment, the first end member 4 is configured, for example, as an end cap that closes the first end E1 side of the cylindrical support 2. The first end member 4 has a plate shape formed of a metal material, particularly austenitic stainless steel with excellent corrosion resistance (SUS 316L in this embodiment). The first end member 4 includes an axially inner end surface that contacts the axially outer end surface 124 of the second support portion 12. By means of the first end member 4, fluid within the space “i” of the support 2 cannot flow out from the first end E1 side of the support 2.

Additionally, the first extension portion 31 is joined to the first end member 4 via a first joint portion 6. In the present embodiment, the first joint portion 6 also joins the first end member 4 and the second support portion 12 of the support 2. However, the first joint portion 6 only needs to join at least the first extension portion 31 and the first end member 4. Furthermore, the first joint portion 6 includes a first raised portion 6A, which has a fourth outer diameter D4 greater than the third outer diameter D3.

### Effect of the Present Embodiment

In the filter medium 3 of the present embodiment, the medium body 30 and the first extension portion 31 extend continuously in the axial direction with the third outer diameter D3. In other words, except for the microscopic irregularities of the medium, the radially outer surfaces of the medium body 30 and the first extension portion 31 are formed as a continuous surface without substantial recesses. Additionally, the first joint portion 6 includes a first raised portion 6A, which has a fourth outer diameter D4 greater than the third outer diameter D3. Accordingly, the metal fiber filter 1 of the present embodiment can suppress the stagnation of the fluid to be filtered on the first end E1 side. Additionally, the first raised portion 6A, which has a relatively large outer diameter (the fourth outer diameter D4), can guide the fluid toward the medium body 30 side, which has a smaller outer diameter. As a result, the metal fiber filter 1 of the present embodiment can contribute to reducing the pressure loss of the fluid to be filtered and generating a uniform flow velocity, thereby achieving excellent filtration efficiency.

Hereinafter, further preferred embodiments of the present invention will be described: however, all of the following are optional components of the present invention.

The first joint portion 6 may be formed using various joining methods. For example, the first joint portion 6 may be formed by welding, brazing, diffusion bonding, or friction welding. From the perspective of preventing fluid leakage (short paths) from the first joint portion 6, welding is particularly preferable, as it easily provides a hermetic joint. Specifically, TIG welding or similar methods are especially desirable. In the present embodiment, the first joint portion 6 is a circumferentially continuous weld bead formed by welding, and the first raised portion 6A is also formed by the portion of this weld bead that is raised radially outward.

The radial protrusion amount of the first raised portion 6A from the outer surface of the filter medium 3 (i.e., (D4−D3)/2) is not particularly limited. However, from the perspective of improving joint strength and facilitating the guidance of fluid toward the medium body 30, it is preferably 0.5 mm or more, and more preferably 0.9 mm or more. In other words, the fourth outer diameter D4 is preferably at least 1.0 mm larger than the third outer diameter D3.

In the present embodiment, the first extension portion 31 of the filter medium 3 has a wall thickness t1 that is smaller than that of the medium body 30. Additionally, since the first extension portion 31 has a porous structure composed of a sintered body of metal fibers, it is more susceptible to deformation and other changes due to heat during welding. However, in the present embodiment, the first extension portion 31 is supported radially inward by the second support portion 12. This support structure suppresses issues such as melting and pore formation during welding, allowing secure joining with the support 2 and the first end member 4. Additionally, since the filter medium 3 has an integrated structure joined to the support 2 and the first end member 4, it possesses high rigidity. As a result, it can exhibit excellent strength even in environments subject to vibration or under high-pressure conditions.

The outer diameter of the first end member 4 (hereinafter referred to as “the fifth outer diameter D5”) is not particularly limited. However, in the present embodiment, it is set to be at least equal to the third outer diameter D3 of the filter medium 3. Accordingly, fluid stagnation can also be suppressed in the vicinity of the first end member 4.

The wall thickness to of the medium body 30 is not particularly limited. However, to further enhance filtration accuracy, it may be set to, for example, 3.0 mm or more, and preferably 3.5 mm or more.

The wall thickness t1 of the first extension portion 31 is also not particularly limited. However, for example, it may be set to at least 5% of the wall embodiments thickness to of the medium body 30, preferably at least 10%, and more preferably at least 15%. By setting the wall thickness t1 of the first extension portion 31 to at least 5% of the wall thickness to of the medium body 30, issues such as melting of the first extension portion 31 during welding with the first end member 4 can be more reliably suppressed. Consequently, a hermetic first joint portion 6 can be formed. This helps effectively prevent fluid short paths near the first joint portion 6.

On the other hand, if the wall thickness t1 of the first extension portion 31 becomes excessively large, it may become difficult to form a deep first joint portion 6 that reaches the second support portion 12. From this perspective, the wall thickness t1 of the first extension portion 31 may be set to, for example, 40% or less of the wall embodiments thickness t0 of the medium body 30, preferably 35% or less, and more preferably 30% or less.

From the above perspective, in one embodiment, when the wall thickness to of the medium body 30 is 5.0 mm, the wall thickness t1 of the first extension portion 31 is preferably in the range of 0.25 to 2.0 mm, more preferably in the range of 0.50 to 1.75 mm, and even more preferably in the range of 0.75 to 1.5 mm.

The porosity of the first extension portion 31 is preferably smaller than that of the medium body 30. This increases the relative rigidity of the first extension portion 31, which is joined to the first end member 4, thereby suppressing welding defects and other issues during joining. In a preferred embodiment, the porosity of the first extension portion 31 is set to, for example, 70% or less, preferably 65% or less, and more preferably 60% or less. The porosity of the first extension portion 31 can be achieved, for example, by adjusting the compression applied to the first extension portion 31 during the sintering process to be higher than that applied to the medium body 30. Additionally, it is preferable that the first extension portion 31 is formed as a porous structure primarily containing pore sizes in the range of 2 to 6 μm (micrometer).

In this specification, the “porosity” of a porous structure refers to the ratio of the volume of voids to the apparent total volume of the target region. In this specification, porosity is determined by calculation. In this method, first, the mass of the filter medium is measured, and the volume of the filter medium, including its voids, is determined. Next, the mass of a solid material with the same volume as the filter medium is measured. Then, the porosity can be calculated using the following equation (1):

$$Porosity ( \% ) = \{ 1 - ( mass of the filter medium / mass of the solid material ) \} * 100 \qquad ( 1 )$$

Since the medium body 30 is supported radially inward by the first support portion 11, it can maintain high differential pressure resistance against the fluid pressure during filtration. As a result, even when the fluid velocity is increased, deformation of the filter medium 3 is suppressed, thereby contributing to improved filtration efficiency. To fully achieve an optimal filtration function, the porosity of the medium body 30 may be set higher than that of the first extension portion 31. In a preferred embodiment, the porosity of the medium body 30 may be set to, for example, 80% or more, preferably 85% or more, and more preferably 90% or more. Similarly, the medium body 30 may be formed as a porous structure that primarily contains larger pore sizes than the first extension portion 31. In a preferred embodiment, the medium body 30 is particularly desirable as a porous structure that primarily contains pore sizes in the range of 5 to 30 μm (micrometer).

### [Third Support Portion]

In the present embodiment, the support 2 further includes a third support portion 13 on the second end E2 side of the first support portion 11, having a sixth outer diameter D6 larger than the first outer diameter D1. In other words, the third support portion 13 protrudes radially outward from the outer surface of the first support portion 11. The outer peripheral surface 131 of the third support portion 13 extends continuously in the axial direction with the sixth outer diameter D6, for example. In this embodiment, the sixth outer diameter D6 is set to be the same as the second outer diameter D2 of the second support portion 12, but it may also be different.

Since the third support portion 13 has the same configuration as the second support portion 12, its detailed description is omitted. That is, the radially outer peripheral surface 131, a radially inner peripheral surface 132, an axially inner end surface 133, and an axially outer end surface 134 of the third support portion 13 have the same configuration as the radially outer peripheral surface 121, the radially inner peripheral surface 122, the axially inner end surface 123, and the axially outer end surface 124 of the second support portion 12, respectively. Additionally, an end portion on the second end E2 side of the first support portion 11 is fixed to the inner peripheral surface 132 of the third support portion 13.

### [Second End Member]

The second end member 5 is joined to the second end E2 side of the support 2. In the present embodiment, the second end member 5 serves as a housing mounting member for securing the second end E2 side of the support 2 to a housing (described later). More specifically, the second end member 5 has a disk shape with an opening 5a formed at its center. The second end member 5 is joined to the second end E2 side of the support 2 with its center aligned with the axial center of the support 2. The outer diameter of the second end member 5 has the largest outer diameter D8 in the metal fiber filter 1, and its outer peripheral portion is fixed to the housing, which will be described later. Additionally, the opening Sa of the second end member 5 is used for extracting fluid from the radially inner space “i” of the support 2.

### [Second Extension Portion]

In the present embodiment, the filter medium 3 includes a second extension portion 32, which is disposed radially outward of the third support portion 13 and joined to the second end member 5. The second extension portion 32 is integrated with the medium body 30 and is used for joining with the second end member 5, as described later.

In the present embodiment, the medium body 30 and the second extension portion 32 extend continuously in the axial direction with the third outer diameter D3. In other words, the medium body 30 and the second extension portion 32 are axially continuous with the same outer diameter, without a substantial step. As mentioned above, the term “without a substantial step” should be understood to mean that a person skilled in the art, under normal attention, can recognize through visual (macroscopic) observation that the connection portion between the medium body 30 and the second extension portion 32 appears continuous in the axial direction with the same outer diameter.

Additionally, the second extension portion 32 is joined to the second end member 5 via a second joint portion 7. In the present embodiment, the second joint portion 7 also joins the second end member 5 and the third support portion 13 of the support 2. However, the second joint portion 7 only needs to join at least the second extension portion 32 and the second end member 5. Furthermore, the second joint portion 7 includes a second raised portion 7A, which has a seventh outer diameter D7 greater than the third outer diameter D3.

In such an embodiment, the medium body 30 and the second extension portion 32 extend continuously in the axial direction with the third outer diameter D3. In other words, except for the microscopic irregularities of the medium, the radially outer surfaces of the medium body 30 and the second extension portion 32 are formed as a continuous surface without substantial recesses. Accordingly, in the present embodiment, the section of the filter medium 3 between the first joint portion 6 and the second joint portion 7 extends continuously in the axial direction with the third outer diameter D3. Thus, the metal fiber filter 1 of the present embodiment can also suppress fluid stagnation on the second end E2 side of the filter medium 3. Additionally, the second raised portion 7A, which has a relatively large outer diameter (the seventh outer diameter D7), can guide the fluid toward the medium body 30 side, which has a smaller outer diameter.

The second joint portion 7 may be formed using various joining methods. For example, the second joint portion 7 may be formed by welding, brazing, diffusion bonding, or friction welding. From the perspective of preventing fluid leakage (short paths) from the second joint portion 7, welding is particularly preferable, as it easily provides a hermetic joint. Specifically, TIG welding or similar methods are especially desirable. In the present embodiment, the second joint portion 7 is also a circumferentially continuous weld bead formed by welding, and the second raised portion 7A is formed by the portion of this weld bead that is raised radially outward.

The radial protrusion amount of the second raised portion 7A from the outer surface of the filter medium 3 (i.e., (D7−D3)/2) is not particularly limited. However, from the perspective of improving joint strength and facilitating the guidance of fluid toward the medium body 30, it is preferably 0.5 mm or more, and more preferably 0.9 mm or more. In other words, the seventh outer diameter D7 is preferably at least 1.0 mm larger than the third outer diameter D3.

In the present embodiment, the second extension portion 32 of the filter medium 3 has a wall thickness t2 that is smaller than that of the medium body 30. Additionally, since the second extension portion 32 has a porous structure composed of a sintered body of metal fibers, it is more susceptible to deformation and other changes due to heat during welding. However, in the present embodiment, the second extension portion 32 is supported radially inward by the third support portion 13. This support structure suppresses issues such as melting and pore formation during welding, allowing secure joining with the support 2 and the second end member 5 while also preventing fluid short paths. Additionally, since the filter medium 3 has an integrated structure joined to the support 2 and the second end member 5, it possesses high rigidity. As a result, it can exhibit excellent strength even in environments subject to vibration or under high-pressure conditions.

The wall thickness t2 of the second extension portion 32 is not particularly limited. However, it is preferably set within the same range as the wall thickness t1 of the first extension portion 31. That is, the wall thickness t2 of the second extension portion 32 may be at least 5% of the wall thickness t0 of the medium body 30, preferably at least 10%, and more preferably at least 15%.

On the other hand, if the wall thickness t2 of the second extension portion 32 becomes excessively large, it may become difficult to form a deep second joint portion 7 that reaches the third support portion 13. From this perspective, the wall thickness t2 of the second extension portion 32 may be set to, for example, 40% or less of the wall thickness to of the medium body 30, preferably 35% or less, and more preferably 30% or less.

From the above perspective, in one embodiment, when the wall thickness to of the medium body 30 is 5.0 mm, the wall thickness t2 of the second extension portion 32 is preferably in the range of 0.25 to 2.0 mm, more preferably in the range of 0.50 to 1.75 mm, and even more preferably in the range of 0.75 to 1.5 mm.

The porosity of the second extension portion 32 is preferably smaller than that of the medium body 30. This increases the relative rigidity of the second extension portion 32, which is joined to the second end member 5, thereby suppressing welding defects and other issues during joining. In a preferred embodiment, the porosity of the second extension portion 32 is set to, for example, 70% or less, preferably 65% or less, and more preferably 60% or less. Additionally, it is preferable that the second extension portion 32 is formed as a porous structure primarily containing pore sizes in the range of 2 to 6 μm (micrometer).

### [Housing]

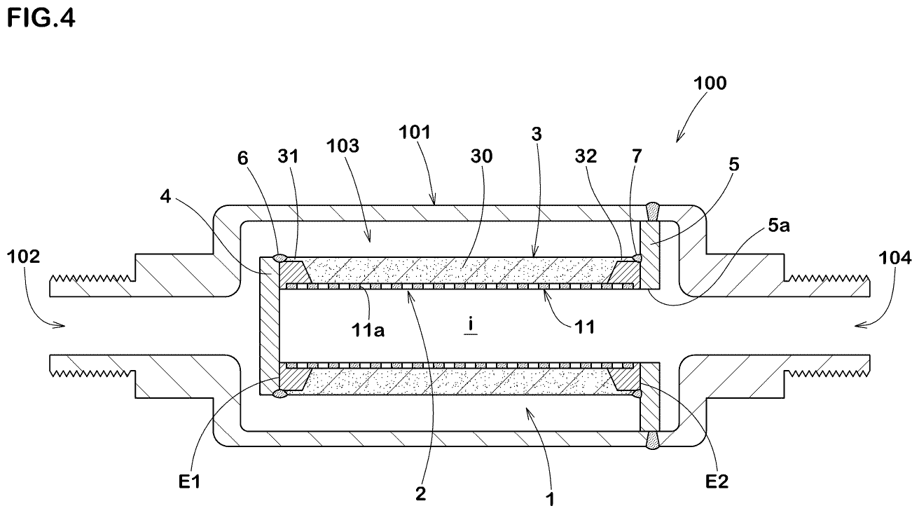

FIG. 4 is a cross-sectional view of a filter unit 100 using the metal fiber filter 1 of the present embodiment. As shown in FIG. 4, the filter unit 100 includes a housing 101 that has a space capable of accommodating the metal fiber filter 1. The housing 101 has an inlet 102 for fluid, an inlet flow path 103 that guides the fluid entering from the inlet 102 to the outer peripheral surface of the filter medium 3, and an outlet 104 for the fluid filtered by the filter medium 3.

The housing 101 is made of, for example, stainless steel, and preferably formed of austenitic stainless steel. In the present embodiment, the housing 101 is particularly composed of SUS 316L, which offers excellent corrosion resistance. The housing 101 forms the outer casing of the metal fiber filter 1, for example, when implemented as an inline filter.

In the filter unit 100 of FIG. 4, the fluid to be filtered, which enters from the inlet 102, passes through the inlet flow path 103 between the housing 101 and the metal fiber filter 1 and then wraps around to the outer peripheral surface side of the filter medium 3. The fluid that wraps around the outer peripheral surface side of the filter medium 3 is filtered as it passes through the filter medium 3, with foreign substances such as fine particles being captured by the filter medium 3 and purified. Furthermore, the purified fluid passes through the through-holes 11a of the first support portion 11, flows through the internal space “i” of the support 2, and then exits through the opening 5a of the second end member 5, from which it is extracted at the outlet 104.

In the filtration process described above, as explained earlier, the outer surfaces of the medium body 30, the first extension portion 31, and the second extension portion 32 of the filter medium 3 extend continuously in the axial direction with the substantially identical third outer diameter D3. Additionally, the first joint portion 6 and the second joint portion 7, located at both axial ends of the filter medium 3, each include the first raised portion 6A and the second raised portion 7A, respectively, which have outer diameters larger than the third outer diameter D3. As a result, fluid is more easily directed from the first raised portion 6A and the second raised portion 7A toward the medium body 30 side, thereby suppressing stagnation at both axial ends of the medium body 30. This leads to a reduction in pressure loss during the filtration process and enables the generation of a uniform flow velocity.

Additionally, since the filter medium 3 is supported radially inward by the support 2, it can maintain high differential pressure strength during filtration, even as a porous structure. Therefore, the metal fiber filter 1 and the filter unit 100 of the present embodiment can be suitably used even in high filtration pressure environments, contributing to an improvement in filtration efficiency in this respect as well.

The metal fiber filter 1 of the present embodiment can reduce the pressure loss associated with filtration. As a result, even when filtering low vapor pressure liquids, it can prevent re-liquefaction within the filter medium 3. Therefore, the metal fiber filter 1 of the present embodiment can also be used as a vaporizer. For example, in semiconductor manufacturing processes, when filtering a low vapor pressure liquid, which is a fluid vaporized from a precursor, re-liquefaction within the filter medium 3 can be prevented.

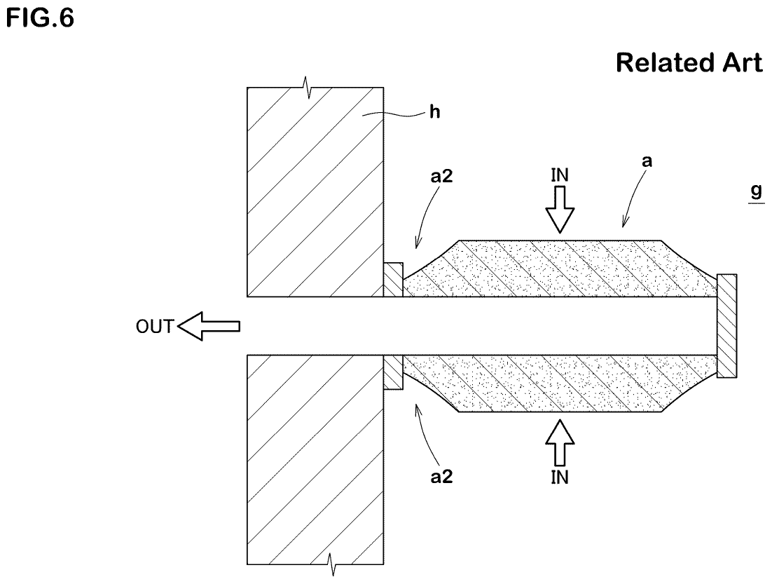

The metal fiber filter 1 of the present invention may also be used without the housing 101. For example, as shown in FIG. 6, when it is implemented as a diffuser (vent filter) mounted in a vacuum chamber, where the filtered gas is directly sent to the next process immediately after filtration, the housing 101 is not required.

The embodiments of the present invention have been described in detail above; however, the present invention is not limited to the specific disclosures provided above and can be variously modified and implemented within the scope of the technical ideas described in the claims.

### DESCRIPTION OF REFERENCE SIGNS

1 Metal fiber filter
2 Support
3 Filter medium
4 First end member
5 Second end member
5a Opening
6 First joint portion
6A First raised portion
7 Second joint portion
7A Second raised portion
11 First support portion
11a Through-hole
12 Second support portion
13 Third support portion
30 Medium body
31 First extension portion
32 Second extension portion
100 Filter unit
101 Housing
102 Inlet
103 Inlet flow path
104 Outlet
E1 First end
E2 Second end

1. A metal fiber filter, comprising
a support having a cylindrical shape defining an axial direction and a radial direction, and having a first end,
a filter medium disposed radially outward of the support, and
a first end member joined to a first end side of the support,
wherein
the support includes a first support portion having a first outer diameter and, a second support portion having a second outer diameter larger than the first outer diameter, positioned on the first end side of the first support portion,
the first support portion is formed with a plurality of through-holes,
the second support portion is joined to the first support portion and forms the first end,
the filter medium is a sintered body of metal fibers,
the filter medium is disposed radially outward of the first support portion and includes a medium body for filtering fluid, and a first extension portion disposed radially outward of the second support portion and joined to the first end member,
the medium body and the first extension portion extend continuously in the axial direction with a third outer diameter,
the first extension portion is joined to the first end member via a first joint portion, and
the first joint portion includes a first raised portion having a fourth outer diameter larger than the third outer diameter.

2. The metal fiber filter according to claim 1, wherein the first raised portion is formed by a weld bead.

3. The metal fiber filter according to claim 1, wherein a wall thickness of the first extension portion is in a range of 5% to 40% of a wall thickness of the medium body.

4. The metal fiber filter according to claim 3, wherein the wall thickness of the medium body is 4.0 mm or more.

5. The metal fiber filter according to claim 1, wherein the first end member has a fifth outer diameter equal to or greater than the third outer diameter.

6. The metal fiber filter according to claim 1, wherein the second support portion is not formed with a through hole penetrating in the radial direction.

7. The metal fiber filter according to claim 1, wherein the fourth outer diameter is at least 1.0 mm larger than the third outer diameter.

8. The metal fiber filter according to claim 1, wherein porosity of the first extension portion is smaller than porosity of the medium body.

9. The metal fiber filter according to claim 1, wherein porosity of the first extension portion is 70% or less, and porosity of the medium body is 80% or more.

10. The metal fiber filter according to claim 1, wherein the first end member is an end cap that closes the first end side of the support.

11. The metal fiber filter according to claim 1, wherein
the support has a second end opposite to the first end,
the support includes a third support portion on a second end side of the first support portion, the third support portion having a sixth outer diameter larger than the first outer diameter,
the third support portion is joined to the first support portion and forms the second end,
a second end member is joined to the second end of the support,
the filter medium includes a second extension portion disposed radially outward of the third support portion and joined to the second end member,
the medium body and the second extension portion extend continuously in the axial direction at the third outer diameter,
the second end side of the second extension portion is joined to the second end member via a second joint portion, and
the second joint portion includes a second raised portion having a seventh outer diameter greater than the third outer diameter.

12. The metal fiber filter according to claim 11, wherein the second raised portion is formed by a weld bead.

13. The metal fiber filter according to claim 11, wherein a wall thickness of the second extension portion is in a range of 5% to 40% of a wall thickness of the medium body.

14. The metal fiber filter according to claim 11, wherein the first end member is an end cap that closes the first end side of the support,
the second end member is a housing mounting member for fixing the second end of the support to a housing, and
the second end member has an opening for extracting fluid from a radially inner space of the support.

15. A filter unit comprising
the metal fiber filter according to claim 14, and
a housing capable of accommodating the metal fiber filter,
wherein
the housing includes
an inlet for the fluid,
an inlet flow passage for guiding the fluid that has entered through the inlet to an outer peripheral surface of the filter medium, and
an outlet for extracting the fluid that has been filtered by the filter medium and passed through the through-holes of the first support portion and the opening of the second end member.

16. A vaporizer using the metal fiber filter according to claim 1.
